(19) United States
(12) Patent Application Publication
(10) Pub. No.: US 2004/0207653 A1
(43) Pub. Date: Oct. 21, 2004

(54) Systems and methods for controlling a display

(76) Inventors: Donald J. Stavely, Windsor, CO (US); Mark J. Bianchi, Ft. Collins, CO (US); David K. Campbell, Loveland, CO (US); Amy E. Battles, Windsor, CO (US); Heather Noel Bean, Ft. Collins, CO (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/417,656

(22) Filed: Apr. 17, 2003

(51) Int. Cl. G09G 5/02

(52) U.S. Cl. 345/698

(57) ABSTRACT

Disclosed are systems and methods for controlling a display. In one embodiment, a system and a method pertain to monitoring the state of a computing device associated with the display, determining if pixel reduction is warranted in view of the monitoring, and, if pixel reduction is warranted, displaying a reduced-pixel, whole image that comprises fewer active pixels than an original, complete image previously presented in the display.

### BACKGROUND

Displays are used with many different computing devices from common desktop personal computers (PCs) to various portable computing devices such as notebook computers, personal digital assistants (PDAs), tablet computers, mobile communicating devices (e.g., cell phones), image capture devices (e.g., digital cameras), and the like. Desktop computing devices typically are used in conjunction with cathode ray tube (CRT) displays or liquid crystal displays (LCDs), while portable computing devices that include displays typically comprise LCDs.

Tube and liquid crystal display technologies have attendant drawbacks that render them unattractive for some applications. One of these drawbacks is that both technologies are relatively energy inefficient. An LCD, for example, relies upon an internal fluorescent light source, such as a fluorescent bulb, that must remain lighted as long as images are to be displayed, irrespective of the size or number of the features that are to be displayed. The reason for this is that the individual elements or pixels that comprise the LCD do not emit light themselves, but instead merely transmit or reflect light provided by the internal light source. Therefore, even when a screen-saver comprising a relatively small, moving feature is displayed in a “sleep mode” of a notebook computer, the fluorescent light source burns the same amount of energy as it would when a full image is displayed.

### SUMMARY

Disclosed are systems and methods for controlling a display. In one embodiment, a system and a method pertain to monitoring the state of a computing device associated with the display, determining if pixel reduction is warranted in view of the monitoring, and, if pixel reduction is warranted, displaying a reduced-pixel, whole image that comprises fewer active pixels than an original, complete image previously presented in the display.

### BRIEF DESCRIPTION OF THE DRAWINGS

The disclosed systems and methods can be better understood with reference to the following drawings. The components in the drawings are not necessarily to scale.

FIG. 1 is a schematic view of an example computing device that includes a display that can be controlled using embodiments of the disclosed systems and methods.

FIG. 2 is a block diagram of an embodiment of the computing device shown in FIG. 1.

FIG. 3 is a flow diagram that illustrates a first embodiment of operation of a display controller shown in FIG. 2.

FIG. 4 is a flow diagram that illustrates a second embodiment of operation of the display controller shown in FIG. 2.

FIGS. 5A-5C are schematic views of a display illustrating reduction in the number of pixels used to represent an image or screen on the display.

### DETAILED DESCRIPTION

As identified above, existing display technologies are relatively energy inefficient. Greater efficiency can be obtained, however, when emissive display technologies are implemented. When an emissive display is used, only display elements or pixels that are needed to display an image or other feature are activated. Therefore, power consumption in such circumstances is content-dependent. As is described in the following, even greater power savings are attainable by controlling the number of display elements or pixels used to generate the images that arc presented to the user. When the display is controlled in this manner, less power is used in that fewer elements are activated. Moreover, the user may still obtain information from the display in that images displayed thereon are still visible to the user.

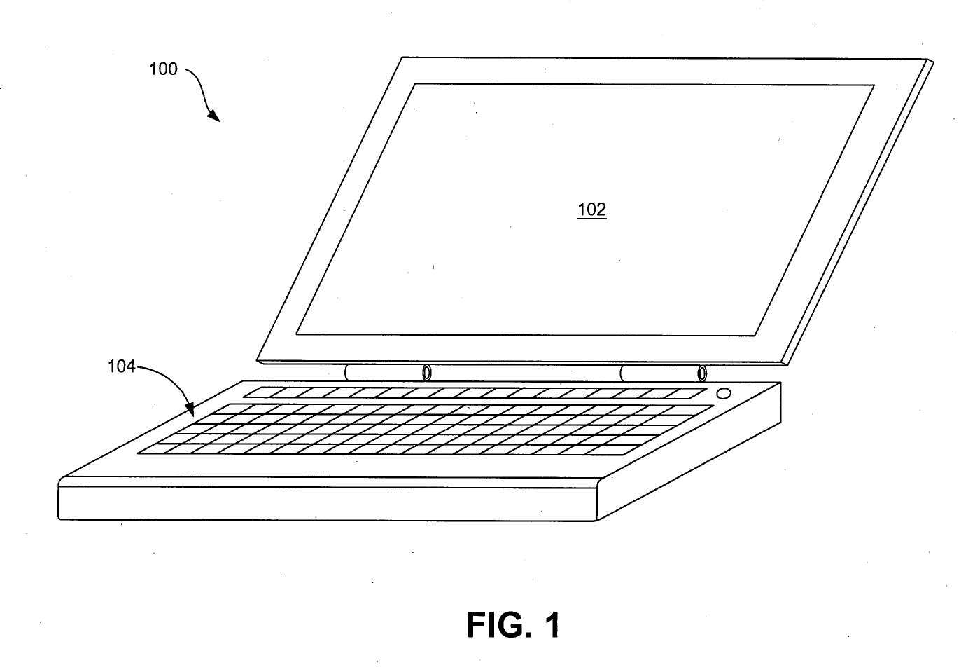

Referring now in more detail to the figures in which like numerals identify corresponding parts, FIG. 1 illustrates an example computing device 100 that incorporates a display 102. The computing device 100 in this example is illustrated as a notebook, or “laptop,” computer. Although a notebook computer is shown, the display may be incorporated into, or otherwise associated with, other computing devices including desktop personal computers (PCs), personal digital assistants (PDAs), tablet computers, mobile communicating devices (e.g., cell phones), image capture devices (e.g., digital cameras), and the like. Due to battery life concerns, however, the greatest benefit from the disclosed systems and methods may potentially be obtained in situations in which the display is incorporated into a battery-powered portable device. As is further indicated in FIG. 1, the computing device 100 includes input devices 104, such as keys or buttons (shown in schematic form), which may be manipulated by the user to enter input.

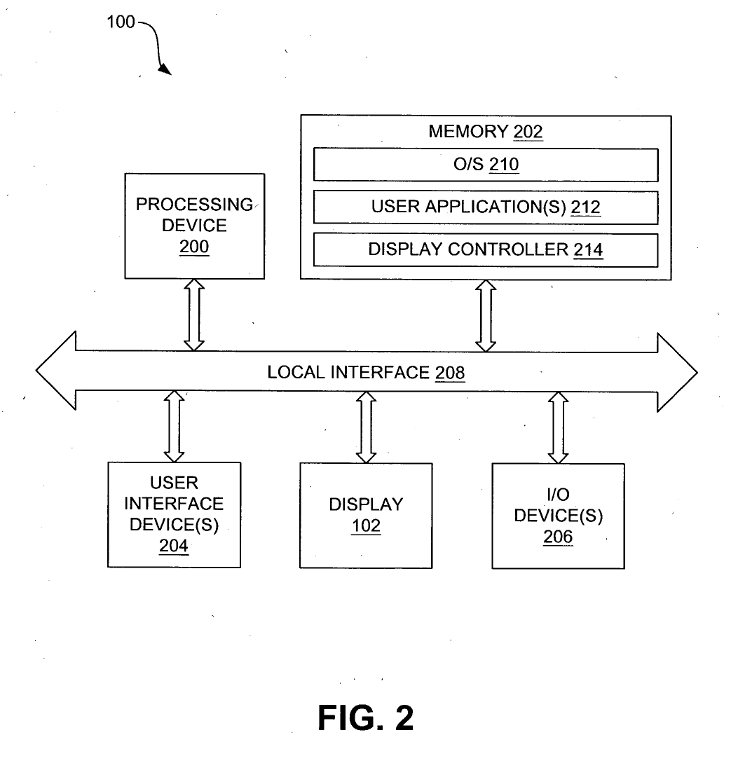

FIG. 2 is a block diagram illustrating an example architecture for the computing device 100 shown in FIG. 1. As indicated in FIG. 2, the computing device 100 comprises a processing device 200, memory 202, user interface devices 204, the display 102 (FIG. 1), and one or more input/output (I/O) devices 206. Each of these components is connected to a local interface 208 that, by way of example, comprises one or more internal buses. The processing device 200 can comprise any custom made or commercially available processor, a central processing unit (CPU) or an auxiliary processor among several processors associated with the computing device 102, a semiconductor based microprocessor (in the form of a microchip), or a macroprocessor. The memory 202 can include any one of a combination of volatile memory elements (e.g., random access memory) and nonvolatile memory elements (e.g., hard drive, Flash memory, etc.).

The user interface devices 204 comprise those components with which the user can interact to enter input into the computing device 100. By way of example, these components comprise a keyboard and mouse. Where the computing device 100 is a handheld device, such as a PDA or mobile telephone, these components can comprise function keys or buttons, a touch sensitive screen, etc.

The display 102 is an emissive display that emits (i.e., generates) light as opposed to merely transmitting or reflecting it. One example of an emissive display is a cathode ray tube (CRT) display. Although the display 102 comprises a CRT-display, the display can alternatively comprise a non-tube emissive display such as an organic light emitting diode (OLED) display. Suitable OLED displays are being developed by Cambridge Display Technology, Pioneer, and Kodak. Because these displays comprise individually energized pixels, the power they consume depends upon the content of the image. Therefore, what is being displayed dramatically affects the total power dissipation of such displays. In any case, the display 102 comprises a plurality of emissive display elements or pixels that together form a viewable composite image.

With further reference to FIG. 2, the I/O devices 206 are adapted to facilitate connection of the computing device 100 to another device and may include one or more serial, parallel, small computer system interface (SCSI), universal serial bus (USB), and/or IEEE 1394 (e.g., Firewire™) components.

The memory 202 stores various programs (in software and/or firmware) including an operating system (O/S) 210, one or more user applications 212, and a display controller 214. The operating system 210 controls the execution of other programs and provides scheduling, input-output control, file and data management, memory management, and communication control and related services. The user applications 212 comprise applications that execute on the computing device 100.

The display controller 214 controls the operation of the display 102 and the manner in which visual information is presented with the display. More particularly, the display controller 214 controls the number of the display elements that are used to display a given image or “screen” in the display 102. As is described below, this number can be controlled in a manner that limits power consumption while still presenting useful visual information to the user.

The various programs described above can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

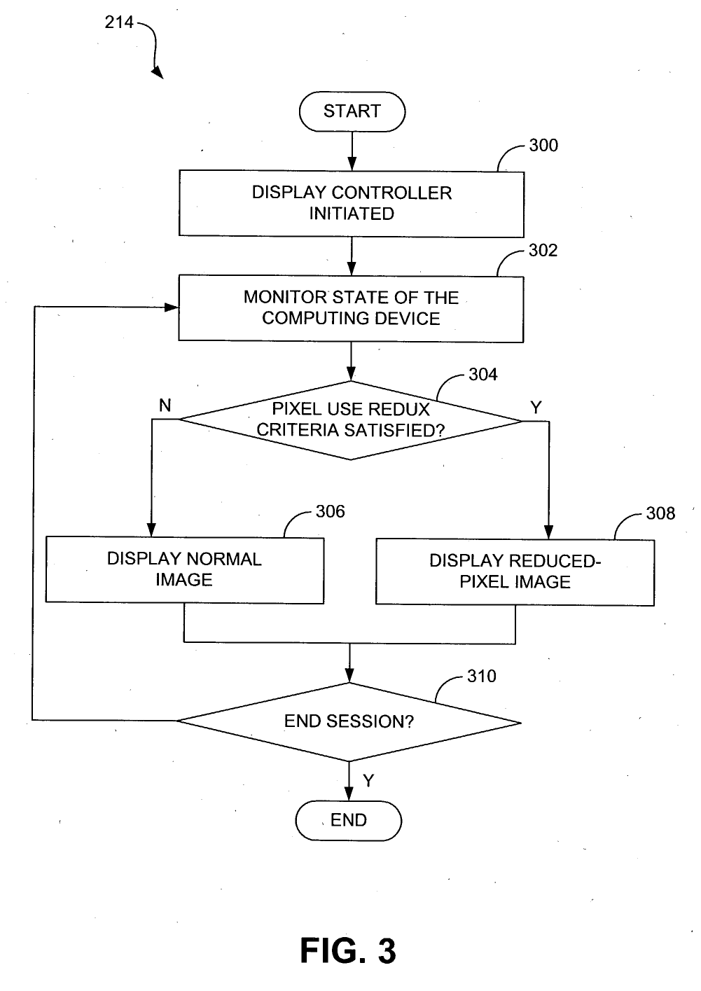

Operation and control of the device display 102 will now be discussed with reference to FIGS. 3-5. In some of these figures, flow diagrams are provided. Any process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

As described above, significant power savings can be obtained by using an emissive display, such as an OLED display, particularly when the display is controlled such that the number of display elements or pixels used to create an image in the display is reduced. FIG. 3 illustrates an embodiment of operation of the display controller 214 (FIG. 2) in controlling a display in this manner. Beginning with block 300, the display controller 214 is initiated. This initiation can occur in response to various different conditions, but normally occurs upon activation of the display and/or computing device that incorporates or uses it.

Once the display controller 214 has been initiated, it monitors the state of the computing device, as indicated in block 302, to determine whether the conditions are present for reducing the number of pixels that are used to generate images shown on the display. In other words, the display controller 214 determines whether predetermined pixel use reduction criteria have been satisfied, as indicated in decision block 304. These conditions or criteria can be preselected so as to activate pixel usage reduction in response to a given situation. By way of example, one such situation may be that in which the estimated remaining life of a power source (e.g., battery) that powers the display falls below a predetermined level. To cite another example, the situation may be elapse of a predetermined period of time during which the computing device is not used by the user. More generally, however, the conditions or criteria may be set to suit the particular results that are desired.

With continued reference to decision block 304, if the pixel use reduction criteria is/are not satisfied, flow continues on to block 306 and the normal, full image is displayed to the user. If, on the other hand, the reduction criteria is/are satisfied, pixel reduction is deemed appropriate and, as indicated in block 308, a reduced-pixel image is displayed. Despite the fact that a reduce-pixel image is displayed, the image is still a “whole” image as opposed to a mere discrete portion of the entire image. There are several manners in which the number of pixels used to generate an image can be reduced. In a first method, the size of the image is reduced such that an image is displayed that is whole, but which occupies less of the display than the original, complete (i.e., full pixel) image. In another method, the size of the original, complete image is maintained but less than all of the pixels that were used to generate the complete image are active, resulting in a whole image having a lower resolution. Alternatively, both of these methods can be implemented simultaneously.

With reference next to decision block 310, it is then determined whether the session has ended. This determination may simply comprise a determination as to whether the display and/or the computing device is being shut-down. If the session is to end, flow for the controller 214 is likewise terminated as indicated in FIG. 3, otherwise flow returns to block 302 and continues in the manner described above.

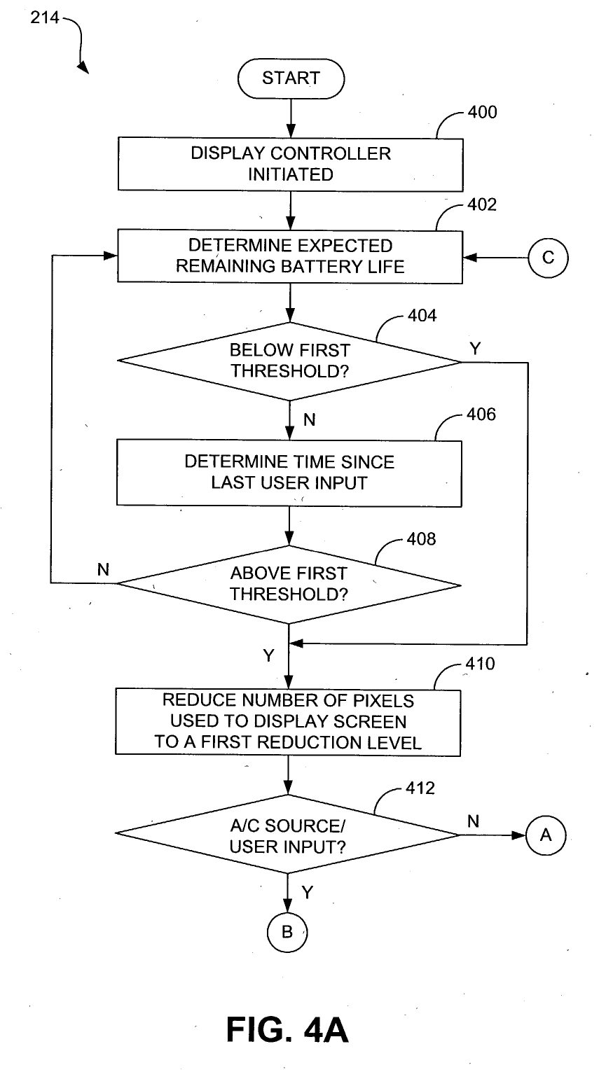

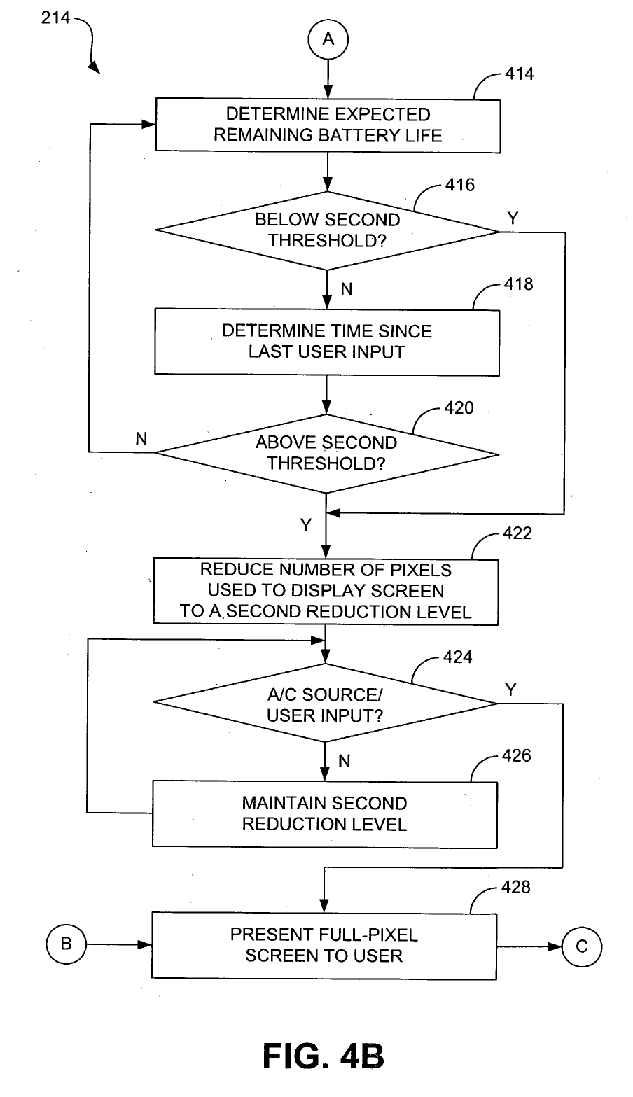

FIGS. 4A and 4B illustrate another embodiment of operation of the display controller 214. In this embodiment, the display is controlled based upon the remaining battery life and/or lack of user input. Beginning with block 400 of FIG. 4A, the display controller 214 is initiated. Again, this initiation can occur in response to various different conditions, but normally occurs upon activation of the display and/or computing device that incorporates or uses it. Alternatively, however, the display controller can be affirmatively initiated by the user as a setting option.

Assuming the display controller 214 has been initiated, it first determines the expected remaining life for a battery that powers the display, as indicated in block 402. In that battery life is often monitored by device operating systems, this information may be obtained through an appropriate request targeted at the operating system of the computing device. With reference to decision block 404, if the remaining battery life is determined to be below a first battery life threshold (e.g., 45 minutes), flow continues to block 410 described below. Assuming that the remaining battery life is not below the first battery life threshold, however, flow continues to block 406 at which the display controller 214 determines the time that has elapsed since the user last entered an input with the computing device. Again, the computing device operating system may already monitor this elapsed time. In such a case, the display controller may receive this information from the computing device operating system.

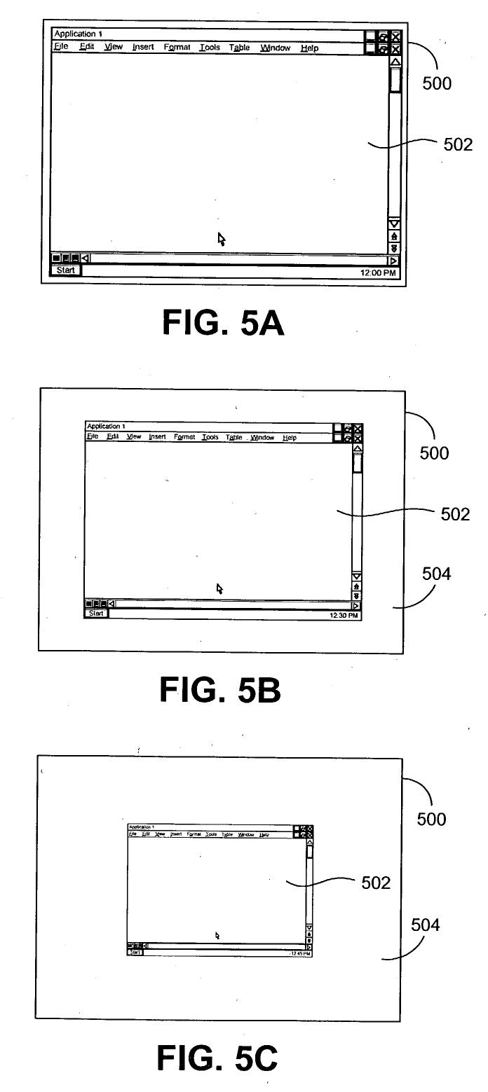

Next, with reference to decision block 408, it is determined whether the amount of time that has elapsed exceeds the first time threshold. If not, flow may then return to block 402. If the elapsed time exceeds the first time threshold, however, or if the battery life was determined to be below the first battery life threshold in decision block 404, flow continues to block 410 at which the number of pixels used to display whole images or “screens” to the user is reduced to a first reduction level. As mentioned above with relation to FIG. 3, this reduction can, for instance, entail reducing the size of the screen and/or reducing the resolution of the screen. An example of the former method is illustrated in FIGS. 5A-5C. Beginning with FIG. 5A, illustrated is a display 500 in which a full-size, complete (i.e., full-pixel) image 502 of a graphical user interface (GUI) is displayed. After a predetermined duration of user inactivity and/or after the battery life falls below a predetermined level, the size of the screen 502 is reduced in a first amount, for instance a given percentage (e.g., 25%), as indicated in FIG. 5B. Due to this reduction, a significant portion 504 of the display, and therefore a significant number of the display pixels, is left unused, thereby reducing power consumption.

At this point in the flow, or at another time if desired, it can be determined whether the conditions have been changed, i.e., whether an alternating current (A/C) source has been connected and/or if the user has entered some form of input (e.g., in response to noticing that the reduced-pixel mode has been implemented), as indicated in decision block 412. If either or both of these conditions have changed, flow continues to block 428 of FIG. 4B discussed below. If not, however, further monitoring is conducted by the display controller 214 to determine whether further reduction in active pixels is warranted. Therefore, with reference to block 414 of FIG. 4B, the display controller 214 again determines the expected remaining life for a battery and whether the determined remaining battery life is below a second battery life threshold (block 416).

Assuming that the remaining battery life is not below the second battery life threshold, flow continues to block 418 at which the display controller 214 determines the time that has elapsed since the user last entered an input and whether that amount of time exceeds a second time threshold (block 420). If not, flow returns to block 414. If the elapsed time exceeds the second time threshold and/or if the battery life was determined to be below the second battery life threshold in decision block 416, flow continues to block 422 at which the number of pixels used to display the screen is reduced to a second reduction level. With reference to FIG. 5C, this may result in an even smaller screen 502 being displayed and, therefore, an even greater portion 504 of the display that is left unused. Again, such an action results in even greater power savings.

Returning to block 424, it can again be determined whether the battery is now being charged or if the user has entered some form of input. If yes, pixel use reduction is no longer appropriate and a complete (i.e., full-pixel) image or screen is presented to the user, as indicated in block 428. At this point, flow returns to block 402 of FIG. 4A. If no such charging and/or input has occurred, however, flow continues to block 426 where the second level of pixel reduction is maintained and flow loops back to decision block 424 to determine if the an A/C source has been connected and/or if the user has entered an input.

Although, in the example of FIGS. 4A and 4B, only two pixel reductions were performed, several such reductions can be made. For instance, the size of the displayed image or screen can be gradually reduced in many steps until the image or screen is the size of a typical “thumbnail” and then simply removed to leave a blank display. Alternatively, the size of the image or screen can continually shrink to the thumbnail size to create the impression of continuous shrinking.

As is apparent from the foregoing, displaying reduced pixel images is advantageous not only from a power conservation standpoint but also from a user feedback standpoint. In one sense, the user can be provided with a clear indication of a given condition (e.g., low battery life remaining or user inactivity) from the changes in the displayed image. In another sense, the user can still see the displayed image or screen even when shown in a reduced-pixel mode and, therefore, can still be alerted to, for instance, arrivals of new email messages and meeting alerts. Moreover, because an image or screen is still presented (as opposed to a blank screen), the user can readily determine whether the computing device is still “on”.

What is claimed is:

1. A method for controlling a display, comprising:
monitoring the state of a computing device associated with the display;
determining if pixel reduction is warranted in view of the monitoring; and
if pixel reduction is warranted, displaying a reduced-pixel, whole image that comprises fewer active pixels than an original, complete image previously presented in the display.

2. The method of claim 1, wherein monitoring comprises monitoring an estimated life of a battery of the computing device.

3. The method of claim 2, wherein pixel reduction is warranted if the estimated life of the battery falls below a predetermined battery life threshold.

4. The method of claim 1, wherein monitoring comprises monitoring the duration of time that has elapsed since a last input entered by a user.

5. The method of claim 4, wherein pixel reduction is warranted if the elapsed time exceeds a predetermined time threshold.

6. The method of claim 1, wherein displaying a reduced-pixel, whole image comprises displaying a whole image having a reduced size.

7. The method of claim 1, wherein displaying a reduced-pixel, whole image comprises displaying a whole image having a reduced resolution.

8. The method of claim 1, further comprising continuing to reduce the number of pixels used to display a whole image until a predetermined condition is satisfied.

9. A method for controlling a display, comprising:
determining an expected remaining life of a battery of a computing device in which the display is used;
determining whether the expected remaining life is below a battery life threshold; and
reducing the size of a complete, originally-displayed image so as to present in the display a whole image of the originally-displayed image using fewer display pixels, if it is determined that the expected remaining life is below -the battery life threshold.

10. The method of claim 9, further comprising:
determining the duration of time that has elapsed since a last input entered by a user;
determining if the elapsed time exceeds a predetermined time threshold; and
reducing the size of the originally-displayed image so as to present in the display a whole image of the originally-displayed image using fewer display pixels, if it is determined that the expected remaining life is below the battery life threshold.

11. The method of claim 9, further comprising continually reducing the number of pixels used to present the whole image until a predetermined condition is satisfied.

12. A display control system, comprising:
means for determining the state of a computing device associated with a display;
means for determining from a determined state whether pixel reduction is warranted; and
means for reducing the number of pixels that are used to display an original, complete image such that a whole, reduce-pixel image can be displayed.

13. The system of claim 12, wherein the means for reducing comprise means for displaying a whole image having a reduced size.

14. The system of claim 12, wherein the means for reducing comprise means for displaying a whole image having a reduced resolution.

15. A display controller stored on a computer-readable medium, comprising:
logic configured to reduce the number of pixels used to present a whole image of an original, complete image in response to a determined condition.

16. The controller of claim 15, further comprising logic configured to determine the remaining life of a battery used to power a display.

17. The controller of claim 15, further comprising logic configured to determine the duration of time that has elapsed since a last input entered by a user.

18. The controller of claim 15, wherein the logic configured to reduce the number of pixels is configured to facilitate display of a reduced-size, whole image of the original, complete image.

19. The controller of claim 15, wherein the logic configured to reduce the number of pixels is configured to facilitate display of a reduced-resolution, whole image of the original, complete image.

20. The controller of claim 15, wherein the logic configured to reduce is configured to continually reduce the number of pixels used to generate the whole image until a predetermined condition is satisfied.

21. A computing device, comprising:
a processing device;
an emissive display; and
a memory containing a display controller comprising logic configured to generate a whole, reduced-pixel image of an original, complete image in response to a determined condition.

22. The computing device of claim 21, wherein the logic configured to generate a whole, reduced-pixel image is configured to generate a reduced-size, whole image.

23. The computing device of claim 21, wherein the logic configured to generate a whole, reduced-pixel image is configured to generate a reduced-resolution, whole image.

24. The computing device of claim 21, wherein the display is an organic light emitting diode (OLED) display.
